(19) United States
(12) Patent Application Publication
(10) Pub. No.: US 2026/0230290 A1
(43) Pub. Date: Aug. 6, 2026

(54) SWITCH MEASUREMENT BEAMS RESOURCES SET TYPE

(71) Applicant: InterDigital Patent Holdings, Inc., Wilmington, DE (US)

(72) Inventors: Haseeb Ur Rehman, Winnipeg (CA); Young Woo Kwak, Woodbury, NY (US); J. Patrick Tooher, Montreal (CA); Yugeswar Deenoo Narayanan Thangaraj, Chalfont, PA (US); Moon-il Lee, Melville, NY (US); Nazli Khan Beigi, Longueuil (CA); Prasanna Herath, Laval (CA); Tejaswinee Lutchoomun, Montreal (CA); Ahmed Mostafa, Ottawa (CA)

(73) Assignee: InterDigital Patent Holdings, Inc., Wilmington, DE (US)

(21) Appl. No.: 19/158,304

(22) PCT Filed: Feb. 23, 2024
(86) PCT No.: PCT/US2024/017080

§ 371 Date: Aug. 20, 2025

Related U.S. Application Data
(60) Provisional application No. 63/447,962, filed on Feb. 24, 2023.

(51) Int. Cl. H04L 5/00; H04W 72/542; H04W 72/563

(52) U.S. Cl. CPC H04L 5/0094; H04W 72/542; H04W 72/563

(57) ABSTRACT

Systems, methods, and instrumentalities are described herein related to switching measurement beams resources set (Set B) type, for example, for artificial intelligence (AI (/machine learning (ML) systems. A device (e.g., a wireless transmit/receive unit (WTRU)) may perform one or more of the following. The device may receive configuration information that indicates: reference signal (RS) resource set(s), a first RS resource selection condition, a second RS resource selection condition, an indication of a first priority associated with the first RS resource selection condition, and an indication of a second priority associated with the second RS resource selection condition. The device may perform measurements on one or more RS resources associated with a respective RS resource set of the RS resource set(s). The device may determine a subset of resources of the measured RS resources based on the first RS resource selection condition and/or the second RS resource selection condition.

### CROSS-REFERENCE TO RELATED APPLICATIONS

This application claims the benefit of U.S. Provisional Application No. 63/447,962, filed Feb. 24, 2023 the contents of which is incorporated by reference herein.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein related to switching measurement beams resources set (Set B) type, for example, for artificial intelligence (AI)/machine learning (ML) systems.

A device (e.g., a wireless transmit/receive unit (WTRU)) may (e.g., be configured to) perform one or more of the following. The device may receive configuration information that indicates: one or more reference signal (RS) resource sets, a first RS resource selection condition, a second RS resource selection condition, an indication of a first priority associated with the first RS resource selection condition, and an indication of a second priority associated with the second RS resource selection condition. The device may perform measurements on RS resources (e.g., on one or more RS resources associated with a respective RS resource set of the one or more RS resource sets). The device may determine a subset of resources of the measured RS resources. The device may determine the subset of resources based on the first RS resource selection condition and/or the second RS resource selection condition. The device may transmit an indication (e.g., associated with the determined subset of resources).

The device may determine that no subset of the measured resources satisfies the first RS resource selection condition. The device may determine to use the second RS resource selection condition (e.g., based on the determination that no subset of the measured resources satisfies the first RS resource selection condition and the second priority being lower than the first priority). The device may determine the subset of measured RS resources based on the subset of measured RS resources satisfying the second RS resource selection condition. The transmitted indication entity may comprise one or more of: an indication of the second RS resource selection condition(s) being satisfied, an indication of a size of the subset, or an indication of RS resources that belong to the determined subset of measured RS resources.

The device may determine that none of the subset of measured RS resources satisfy the second RS resource selection condition. The transmitted indication may comprise a request to fallback to a legacy beam management mode.

The device may determine the subset of measured RS resources based on the subset of measured RS resources satisfying the first RS resource selection condition.

The device may determine a trigger condition is satisfied. The determination (e.g. by the device) of a subset of resources may be based on the trigger condition being satisfied. The trigger condition may be one or more of: a channel parameter of the WTRU or a status of the WTRU. For example, the trigger condition may be a mobility associated with the WTRU being below a threshold.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIGS. 2A-2D Illustrate an example of random access procedures.

### DETAILED DESCRIPTION

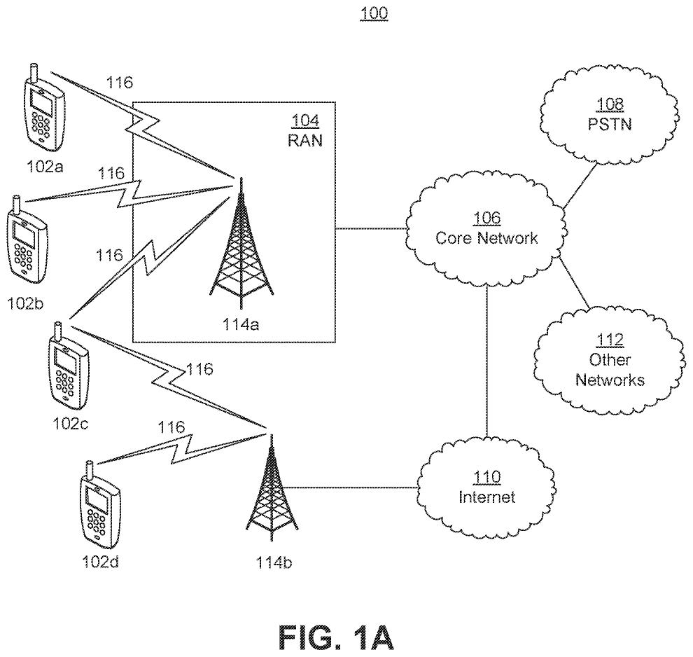

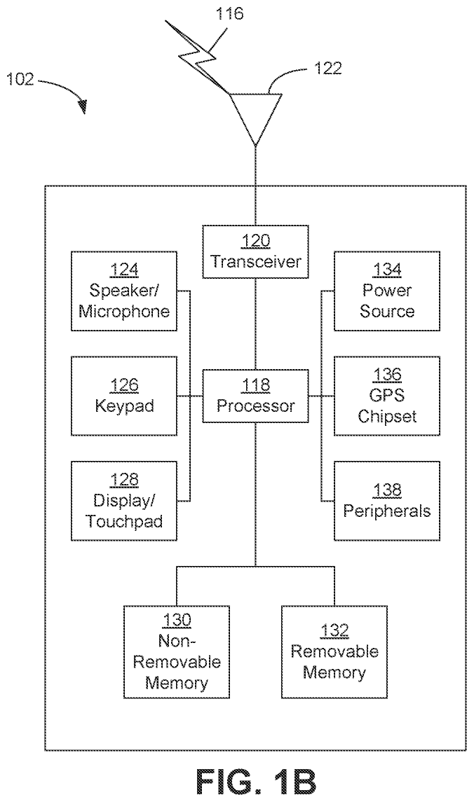

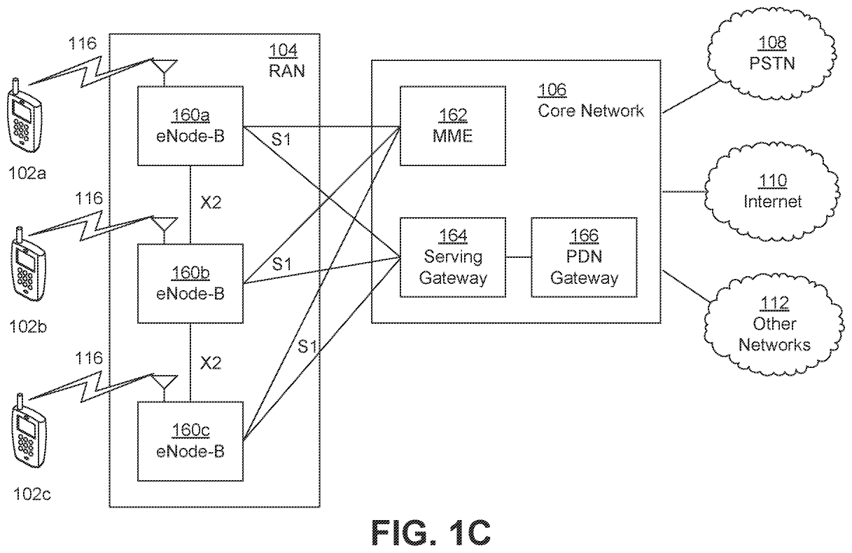

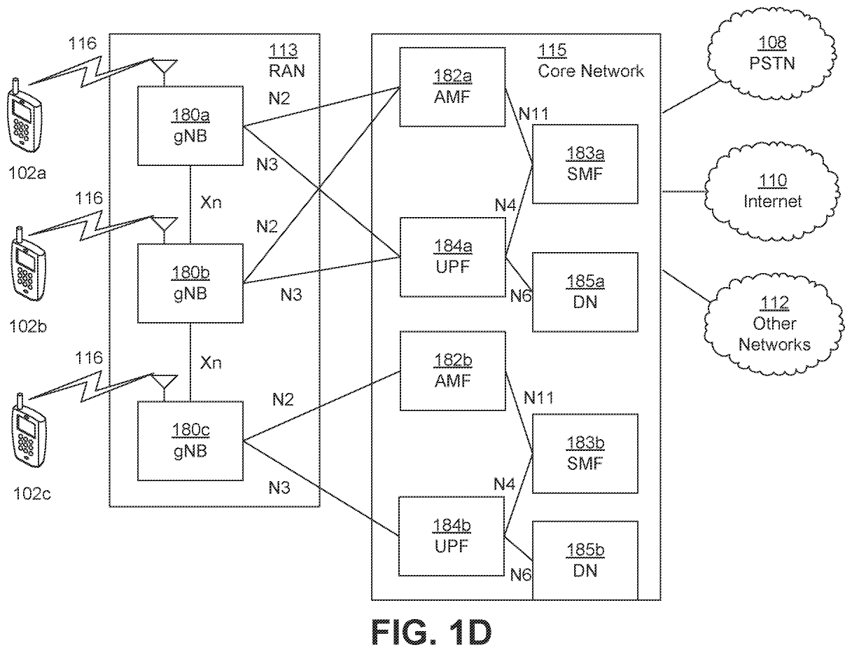

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-FI device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WIFI), IEEE 802.16 (i.e., Worldwide Interoperability for Microwave Access (WIMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN) and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFI radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology, For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A radio access network (RAN) may support an Artificial Intelligence (AI)/Machine Learning (ML) NR air interface. A target use-case for AI/ML for air interface may be beam management, which may be used to improve performance and/or reduce complexity in beam management aspects, e.g., including beam prediction in time and/or spatial domains for overhead and/or latency reduction, beam selection accuracy improvement, and so forth.

AI/ML applications with respect to beam management may predict the best beam (e.g., or beam pairs) among a set of beams (e.g., or beam pairs) with more accuracy and less overhead than at least some other beam management procedures. In some beam management procedures, a WTRU may measure reference signals (RSs) associated with a beam to determine beam quality. The best beam(s) may be reported among the measured beams. In contrast, an AI/ML model in a WTRU (e.g., or gNB) may predict one or more beams (e.g., or beam pairs) out of (e.g., all) possible beams (e.g., or beam pairs), which may include beams (e.g., or beam pairs) not measured by the WTRU (e.g., or gNB). The input to an AI/ML model may be beam measurements and/or beam parameters of a set of beams/beam-pairs, denoted by Set B, which may also be called a measurement set. Set B may be a subset of Set A, which may be called a predicted set. Set A may Include (e.g., all) possible beams/bear-pairs. An AI/ML model in a WTRU (e.g., or gNB) may predict one or more beams (e.g., or beam pairs) of Set A, for example, by inputting beam measurements and/or beam parameters of beams (e.g., or beam pairs) of Set B.

An AI/ML model may be trained with different types and/or sizes of Set B. An AI/ML model trained with a larger Set B size may improve prediction accuracy at the cost of overhead and vice versa. An AI/ML model trained with a (e.g., single) fixed Set B may perform better at the cost of flexibility in input to the AI/ML model. In contrast, an AI/ML model trained with multiple or random Set B(s) may have higher flexibility in input to the AI/ML model at the cost of performance.

A measurement beams resource set referred to as a set B (e.g., an optimal Set B) may be determined, switched, and/or indicated/reported.

The words ‘a’ and ‘an’ and similar phrases may be interpreted as “one or more” and “at least one.” A term that ends with the suffix “(s)” may be interpreted as “one or more” and “at least one.”

Artificial intelligence (AI) may be defined as the behavior exhibited by machines. AI behavior may mimic cognitive functions to sense, reason, adapt, and/or act.

Machine learning (ML) may refer to a type of algorithms that solve a problem based on learning through experience (e.g., data), without (e.g., explicitly) being programmed (e.g., configuring a set of rules). Machine learning may be considered as a subset of AI. Different machine learning paradigms may be implemented based on the nature of data and/or feedback available to the learning algorithm. For example, a supervised learning approach may involve learning a function that maps input to an output based on one or more labeled training examples. A training example (e.g., each training example) may be a pair including an input and a corresponding output. An unsupervised learning approach may involve detecting patterns in the data without pre-existing labels. A reinforcement learning approach may involve performing a sequence of actions in an environment to maximize the cumulative reward. In some examples, machine learning algorithms may be applied using a combination and/or interpolation of machine learning approaches. For example, a semi-supervised learning approach may use a combination of (e.g., a small amount of) labeled data with (e.g., a large amount of) unlabeled data during training. Semi-supervised learning may fall between unsupervised learning (e.g., without labeled training data) and supervised learning (e.g., with only labeled training data).

Deep learning (DL) may refer to a class of machine learning algorithms that employ artificial neural networks (e.g., deep neural networks (DNNs)), which may be inspired from biological systems. Deep neural networks (DNNs) may be a special class of machine learning models inspired by the human brain. A DNN input may be linearly transformed and passed through a non-linear activation function multiple times. DNNs may include multiple layers. A (e.g., each) layer may include a linear transformation and/or one or more non-linear activation functions. DNNs may be trained, for example using training data via a back-propagation algorithm. DNNs may provide state-of-the-art performance in variety of domains, for example, speech, vision, natural language, etc. for various machine learning settings (e.g., supervised, unsupervised, and/or semi-supervised). The term AIML based methods/processing may refer to realization of behaviors and/or conformance to requirements by learning based on data, for example, without (e.g., explicit) configuration of a sequence of steps or actions. AIML based methods may enable learning complex behaviors, which may be difficult to specify and/or implement using other (e.g., legacy) methods.

A WTRU may transmit or receive a physical channel or reference signal according to at least one spatial domain filter. The term “beam” may be used to refer to a spatial domain filter.

A WTRU may transmit a physical channel or signal using a spatial domain filter, for example, the same spatial domain filter used for receiving an RS (e.g., a channel state information (CSI)-RS) or a synchronization signal (SS) block. A WTRU transmission may be referred to as a target. The received RS or SS block may be referred to as a reference or source. The WTRU may (e.g., be said to) transmit the target physical channel or signal according to a spatial relation with a reference to the RS or SS block.

A WTRU may transmit a first physical channel or signal according to a spatial domain filter, for example, the same spatial domain filter used for transmitting a second physical channel or signal. The first and second transmissions may be referred to as target and reference (e.g., or source), respectively. The WTRU may (e.g., be said to) transmit the first (e.g., target) physical channel or signal according to a spatial relation with a reference to the second (e.g., reference) physical channel or signal.

A spatial relation may be implicit, configured by RRC, and/or signaled, such as by a medium access control (MAC) control element (CE) or downlink control information (DCI). For example, a WTRU may (e.g., implicitly) transmit a physical uplink shared channel (PUSCH) and/or a demodulation reference signal (DM-RS) of PUSCH according to the same spatial domain filter as a sounding reference signal (SRS) indicated by an SRS resource indicator (SRI) indicated in DCI or configured by RRC. In some examples, a spatial relation may be configured by RRC for an SRI or signaled by a MAC CE for a physical uplink control channel (PUCCH). A spatial relation may (e.g., also) be referred to as a beam indication.

A WTRU may receive a first (e.g., target) downlink channel or signal according to the same spatial domain filter or spatial reception parameter as a second (e.g., reference) downlink channel or signal. For example, an association may exist between a physical channel, such as PDCCH or PDSCH, and the physical channel's respective DM-RS. The association may exist, for example, if/when the first and second signals are reference signals and/or if/when the WTRU is configured with a quasi-colocation (QCL) assumption type D between corresponding antenna ports. An association may be configured as a transmission configuration indicator (TCI) state. A WTRU may be indicated an association between a CSI-RS or SS block and a DM-RS, for example, by an index to a set of TCI states configured by RRC and/or signaled (e.g., by a MAC CE). An Indication of an association between a CSI-RS or SS block and a DM-RS may (e.g., also) be referred to as a beam indication.

A transmission and reception point (TRP) may be used interchangeably with one or more of transmission point (TP), reception point (RP), radio remote head (RRH), distributed antenna (DA), base station (BS), a sector (e.g., of a BS), and/or a cell (e.g., a geographical cell area served by a BS). A multi-TRP may be used interchangeably with one or more of MTRP, M-TRP, and/or multiple TRPs.

A WTRU may report a subset of channel state information (CSI) components. CSI components may correspond to one or more of the following: a CSI-RS resource indicator (CRI), an SSB resource indicator (SSBRI), an indication of a panel used for reception at the WTRU (e.g., a panel identity or group identity), measurements, such as layer one (L1)-reference signal received power (RSRP), L1-signal to interference and noise ratio (SINR) taken from SSB or CSI-RS (e.g., cri-RSRP, cri-SINR, ssb-Index-RSRP, ssb-Index-SINR), and/or other channel state information, such as a rank indicator (RI), a channel quality indicator (CQI), a precoding matrix indicator (PMI), a layer index (LI), and/or the like.

Channel and/or interference measurements may be performed. A WTRU may receive a synchronization signal/physical broadcast channel (SS/PBCH) block. The SS/PBCH block (SSB) may include a primary synchronization signal (PSS), a secondary synchronization signal (SSS), and/or a physical broadcast channel (PBCH). The WTRU may monitor, receive, and/or (e.g., attempt to) decode an SSB, for example, during one or more of the following: initial access, initial synchronization, radio link monitoring (RLM), cell search, cell switching, and so forth.

A WTRU may measure and report channel state information (CSI). The CSI for a connection mode (e.g., each connection mode) may include or may be configured with one or more of following: a CSI report configuration; a CSI-RS resource set; or non-zero power (NZP) CSI-RS resources.

A CSI report configuration may include one or more of the following: a CSI report quantity (e.g., Channel Quality Indicator (CQI), Rank Indicator (RI), Precoding Matrix Indicator (PMI), CSI-RS Resource Indicator (CRI), Layer Indicator (LI), etc.); a CSI report type (e.g., aperiodic, semi persistent, periodic); a CSI report codebook configuration (e.g., Type I, Type II, Type II port selection, etc.); or a CSI report frequency.

A CSI-RS resource set may include one or more of the following CSI Resource settings: an NZP-CSI-RS resource for a channel measurement; an NZP-CSI-RS resource for an interference measurement; or a CSI interference measurement (CSI-IM) resource for interference measurement.

NZP CSI-RS resources may include one or more of the following: an NZP CSI-RS resource identifier (ID); a periodicity and/or offset; QCL info and/or TCI-state; or resource mapping (e.g., number of ports, density, CDM type, etc.).

A WTRU may indicate, determine, or be configured with one or more reference signals. A WTRU may monitor, receive, and/or measure one or more parameters based on the respective reference signals. For example, one or more of the following parameters may be included in reference signal(s) measurements: SS-RSRP; CSI-RSRP; SS-SINR; CSI-SINR; RSSI; CLI-RSSI; or SRS-RSRP.

SS reference signal received power (SS-RSRP) may be measured, for example, based on synchronization signals (e.g., demodulation reference signal (DMRS) in PBCH or SSS). SS-RSRP may be defined as the linear average over the power contribution of the resource elements (RE) that carry the respective synchronization signal. In measuring the RSRP, power scaling for the reference signals may be used (e.g., required). SS-RSRP measurement (e.g., if used for L1-RSRP) may be accomplished, for example, based on CSI reference signals and the synchronization signals.

CSI-RSRP may be measured based on the linear average over the power contribution of the REs that carry the respective CSI-RS. The CSI-RSRP measurement may be configured within measurement resources for the configured CSI-RS occasions.

An SS signal-to-noise and interference ratio (SS-SINR) may be measured based on the synchronization signals (e.g., DMRS in PBCH or SSS). SS-SINR may be defined as the linear average over the power contribution of the REs that carry the respective synchronization signal divided by the linear average of the noise and interference power contribution. The noise and interference power measurement may be accomplished based on resources configured by higher layers, for example, if/when SS-SINR is used for L1-SINR.

CSI-SINR may be measured, for example, based on the linear average over the power contribution of the REs that carry the respective CSI-RS divided by the linear average of the noise and interference power contribution. The noise and interference power measurement may be accomplished based on resources configured by higher layers, for example, if/when CSI-SINR is used for L1-SINR. The noise and interference power may be measured based on the resources that carry the respective CSI-RS, for example, if/when CSI-SINR is not used for L1-SINR.

A received signal strength indicator (RSSI) may be measured, for example, based on the average of the total power contribution in configured OFDM symbols and bandwidth. The power contribution may be received from different resources (e.g., co-channel serving and non-serving cells, adjacent channel interference, thermal noise, and so forth).

A cross-layer interference received signal strength indicator (CLI-RSSI) may be measured, for example, based on the average of the (e.g., total) power contribution in configured OFDM symbols of the configured time and/or frequency resources. The power contribution may be received from different resources (e.g., cross-layer interference, co-channel serving and non-serving cells, adjacent channel interference, thermal noise, and so forth).

Sounding reference signals RSRP (SRS-RSRP) may be measured, for example, based on the linear average over the power contribution of the REs that carry the respective SRS.

A beam/CSI report configuration (e.g., CSI-ReportConfigs) may be associated with a (e.g., single) bandwidth part (BWP) (e.g., indicated by BWP-Id), where one or more of the following parameters may be configured: CSI-RS resources and/or CSI-RS resource sets for channel and interference measurement; CSI-RS report configuration type (e.g., Including periodic, semi-persistent, and aperiodic); CSI-RS transmission periodicity for periodic and semi-persistent CSI reports; CSI-RS transmission slot offset for periodic, semi-persistent and aperiodic CSI reports; CSI-RS transmission slot offset list for semi-persistent and aperiodic CSI reports; time restrictions for channel and interference measurements; report frequency band configuration (e.g., wideband/subband CQI, PMI, and so forth); thresholds and modes of calculations for the reporting quantities (e.g., CQI, RSRP, SINR, LI, RI, etc.); codebook configuration; group based beam reporting; CQI table; subband size; non-PMI port indication; port Index; etc.

A CSI-RS resource configuration may be determined and/or provided. A CSI-RS resource set (e.g., NZP-CSI-RS-ResourceSet) may include one or more CSI-RS resources (e.g., NZP-CSI-RS-Resource and CSI-ResourceConfig). A WTRU may be configured with one or more of the following in a CSI-RS resource: CSI-RS periodicity and slot offset for periodic and semi-persistent CSI-RS resources;

CSI-RS resource mapping to define the number of CSI-RS ports, density, CDM-type, OFDM symbol, and/or subcarrier occupancy; the bandwidth part to which the configured CSI-RS is allocated; or a reference to the TCI-State (e.g., including the QCL source RS(s) and the corresponding QCL type(s).

An RS resource set may be configured. One or more configurations may be used for an RS resource set. A WTRU may be configured with one or more RS resource sets. An RS resource set configuration may include one or more of following: an RS resource set ID; one or more RS resources for the RS resource set; repetition (e.g., on or off); an aperiodic triggering offset (e.g., one of 0-6 slots); or TRS info (e.g., true or not),

RS resources may be configured. One or more configurations may be used for RS resources. A WTRU may be configured with one or more RS resources. An RS resource configuration may include one or more of following: an RS resource ID; a resource mapping (e.g., REs in a PRB); a power control offset (e.g., one value of −8, . . . , 15); a power control offset with SS (e.g., −3 dB, 0 dB, 3 dB, 6 Db); a scrambling ID; a periodicity and offset; or QCL information (e.g., based on a TCI state).

A grant or assignment may have one or more properties. A property of a grant or assignment may include, for example, one or more of the following: a frequency allocation; an aspect of time allocation, such as a duration; a priority; a modulation and coding scheme (MCS); a transport block size; a number of spatial layers; a number of transports blocks; a TCI state, CRI, and/or SRI; a number of repetitions; an indication whether the repetition scheme is Type A or Type B; an indication whether the grant is a configured grant type 1, type 2, or a dynamic grant; an Indication whether the assignment is a dynamic assignment or a semi-persistent scheduling (e.g., configured) assignment; a configured grant index or a semi-persistent assignment index; a periodicity of a configured grant or assignment; a channel access priority class (CAPC); or a (e.g., any) parameter provided (e.g., in a DCI, by MAC, or by RRC) for scheduling the grant or assignment.

An indication by DCI may include, for example, one or more of the following: an (e.g., explicit) indication by a DCI field or by RNTI used to mask a CRC of the PDCCH; and/or an (e.g., implicit) indication by a property, such as DCI format, DCI size, CORESET or search space, aggregation level, first resource element of the received DCI (e.g., index of first Control Channel Element), where the mapping between the property and the value may be signaled by RRC or MAC.

Reference signal (RS) may be used interchangeably with one or more of the following: RS resource, RS resource set, RS port, RS port group, or beam group. RS may (e.g., also) be used interchangeably with one or more of following: a sounding reference signal (SRS); channel state information-reference signal (CSI-RS); a demodulation reference signal (DM-RS); a phase tracking reference signal (PT-RS); a timing reference signal (TRS), a positioning reference signal (PRS), or a synchronization signal block (SSB).

Channel may be used interchangeably with one or more of following: physical downlink control channel (PDCCH); physical downlink shared channel (PDSCH); physical uplink control channel (PUCCH); physical uplink shared channel (PUSCH); physical random access channel (PRACH); etc.

A signal, channel, and/or message (e.g., as in DL or UL signal, channel, and/or message) may be used interchangeably.

Beam reporting may be used interchangeably with CSI measurement, CSI reporting, and/or beam measurement.

Examples (e.g., as described herein) for beam resources prediction may be used for beam resources belonging to one or more (e.g., single or multiple) cells and/or one or more (e.g., single or multiple) TRPs.

Set A may be used interchangeably with a set of one or more of the following: RS resource sets, beams, beam-pairs, beam RS resources, RS resources, and/or a beam pattern. In examples, Set A may be a set of all beams.

Set B may be used interchangeably with a set of one or more of the following: RS resource sets, beams, beam-pairs, beam RS resources, RS resources, and/or a beam pattern. In examples, Set B may be a set of measured beams (e.g., Set B may be a subset of Set A).

A measurement beams resource set (e.g., Set B) may be selected/indicated, for example, during initial access. A WTRU may have a (pre)defined initial/default Set B and/or Set B size. For example, a random Set B may have a (e.g., default) size of N beams. For example, a fixed Set B may include common (e.g., not WTRU-specific) gNB beams.

A WTRU may switch to another Set B type (e.g., fixed Set B, random Set B) based on initial measurements (e.g., initial beams RSRPs, indicated beam IDs) and/or availability of (pre)defined/(pre)configured Set B(s), for example, If the measured beams' IDs/QCL-TypeD information match with the beams of a (pre)configured Set B. Measured beams may match with the beams of a Set B associated with an AI/ML model. A WTRU may send an indication to a gNB about the selection of beams of Set B(s), for example, a WTRU specific preconfigured Set B. A WTRU may report supported Set B types (e.g., fixed, random, etc.), for example, as part of WTRU capability. A WTRU may determine/indicate future preferred Set B(s) (e.g., measurement-RS resources), for example, according to the WTRU's reported capability.

The terms initial access and random access may be used interchangeably to refer to the one or more procedures associated with establishing connectivity between a WTRU and a network.

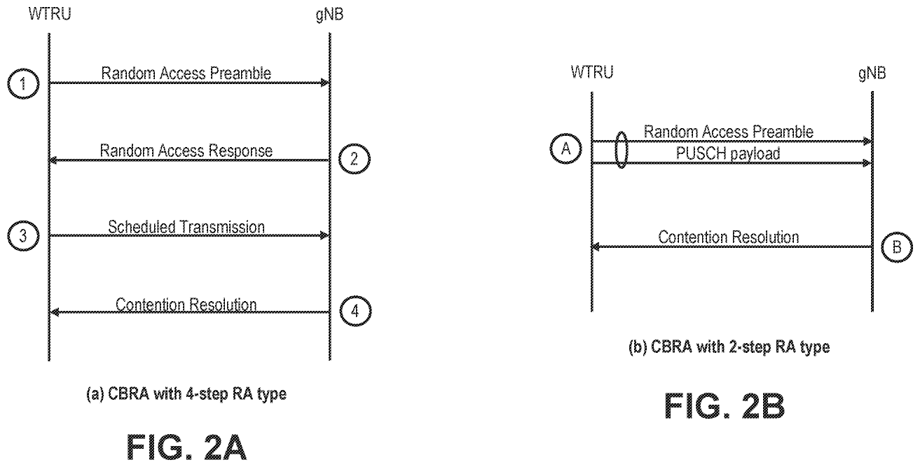

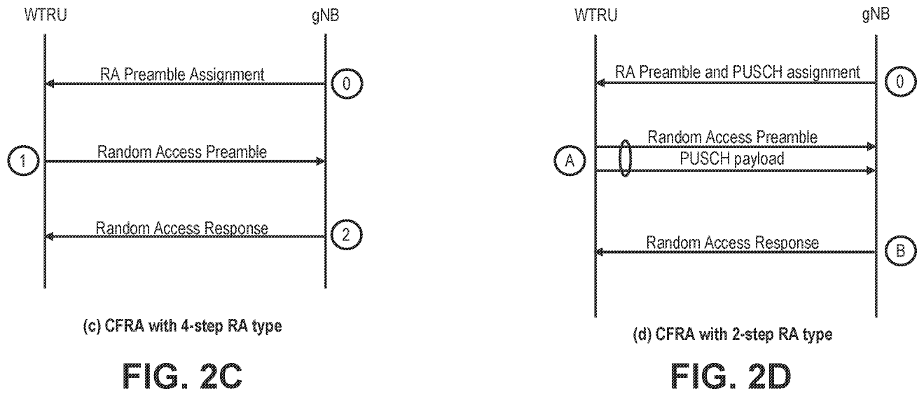

Random access procedures may be implemented in a network (e.g., an NR network), FIGS. 2A-D illustrates an example of random access procedures.

Multiple (e.g., two) types of random access procedure may be supported (e.g., 4-step RA type with MSG1 and 2-step RA type with MSGA). One or more types (e.g., both types) of RA procedure may support contention-based random access (CBRA) and/or contention-free random access (CFRA), for example, as shown in FIGS. 2A-D.

A WTRU may select the type of random access at initiation of a random access procedure based on a network configuration. An RSRP threshold may be used by a WTRU to select between 2-step RA type and 4-step RA type, for example, if/when CFRA resources are not configured. A WTRU may perform random access with 4-step RA type, for example, if/when CFRA resources for 4-step RA type are configured. A WTRU may perform random access with 2-step RA type, for example, if/when CFRA resources for 2-step RA type are configured.

A RACH Occasion (RO) may be a space in the time and/or frequency domain for the reception of the RACH preamble.

In some examples (e.g., in LTE), there may be (e.g., only) one RACH occasion specified by an RRC message (e.g., in SIB2) for (e.g., all) the possible RACH preambles. In some examples (e.g., in NR), an SSB is associated with different beams and/or the WTRU may select a beam and send the preamble using the selected beam.

A mapping may be defined/configured between SSB and RACH occasion(s) by the gNB. A SSB (e.g., each SSB) may be associated with different beam(s). A WTRU may select a beam and send a preamble using the selected beam. The gNB may know which beam(s)/SSB(s) the WTRU has selected, for example, based on the configuration between SSB and RACH occasion(s), and/or the RACH occasion selected by the WTRU to send the preamble. An initial/default set B may be (e.g., implicitly) indicated by the WTRU to the gNB, for example, based on the RACH occasion selected by the WTRU to send the preamble.

A WTRU may have a (e.g., predefined) initial/default Set B and/or Set B size. An initial/default Set B and/or Set B size may be, for example, a random Set B with a default size of N beams. An initial/default Set B and/or Set B size may be, for example, a fixed Set B comprising common (e.g., not WTRU-specific) beams. A WTRU may send an indication to the gNB on the initial/default Set B and/or set B size explicitly or implicitly (e.g., by selecting a preamble accordingly, for example, as described herein).

A WTRU may switch to another Set B type (e.g., fixed Set B, random Set B) based on initial measurements (e.g., initial beams RSRPs, indicated beam IDs) and/or availability of predefined/preconfigured Set B(s), for example, if the measured beams' IDs/QCL-TypeD information match with the beams of preconfigured Set B. Measured beams may match with the beams of a Set B associated with an AI/ML model. A WTRU may send an indication to a gNB about a selection of beams of Set B(s), for example, WTRU specific preconfigured Set B. An indication may be sent implicitly or explicitly. For example, an indication may be sent implicitly via the selection of preamble (e.g., as described herein). A WTRU may report supported Set B types (e.g., fixed, random, etc.), for example, as part of an initial capability exchange with the network (e.g., during RRC (re)configuration). A WTRU may determine/indicate a future preferred Set B(s) (e.g., RS resources/beams), for example, according to the WTRU's reported capability.

A WTRU may report information on set B, for example, via an initial access preamble. An initial access preamble (e.g., referred to as a random access preamble or preamble) may be sent from a WTRU to a gNB (e.g., in Msg 1, Msg 3, Msg 5, and/or Msg A). A preamble may be selected by a WTRU in a contention-based manner. A preamble may be a dedicated preamble designated/reserved by the gNB in a contention-free manner. A preamble may be transmitted as part of a (e.g., not limited to conventional) random access procedure (e.g., CBRA with 4-step RA type, CBRA with 2-step RA type, CFRA with 4-step RA type, CFRA with 2-step RA type).

In some examples, a gNB may provide a list of preambles that may be contention-free for the WTRU to perform initial access. The contention-free preamble(s) may correspond to the same or to a different set of resources (e.g., RACH Occasions in the time domain, PRACH Occasions in the frequency domain, SSBs corresponding to one or multiple beams in the spatial domain) as the contention-based preamble(s). For example, a WTRU may select a contention-free preamble. The WTRU may send the contention-free preamble on a RACH Occasion to the gNB. A gNB may know which beams/SSBs the WTRU has selected, for example, based on the RACH occasion used by the WTRU, which may represent the initial/default set B for the WTRU.

In some examples, a preamble may serve a (e.g., an additional) purpose, for example, versus (e.g., only) serving to achieve uplink synchronization. A preamble may (e.g., implicitly) provide additional information on set B. A WTRU may select preamble 1 or 2, for example, if the size of set B of RS resources/beams=S1. A WTRU may select preamble 3 or 4, for example, if size of set B of RS resources/beams=S2, and so forth. WTRU may select preamble 5 or 6, for example, if set B is a fixed set. WTRU may select preamble 7 or 8 for example, if set B is a random set, and so forth.

A preamble may provide additional information, for example, as listed herein (e.g., explicitly) on set B, for example, through the addition of extra bits to the legacy preamble to carry more information. An indication may be a flag, for example. For example, the presence of a flag may indicate a Set B type (e.g., a fixed Set B versus a random Set B). An Indication may be more complex, for example, by providing extra bits to indicate the number of RS resources/beams in the set B at the WTRU.

In some examples, there may be multiple (e.g., two) types of preambles. A first (e.g., legacy) type of preamble may serve to achieve UL synchronization between a WTRU and a network (NW). A second (e.g., enhanced/special) type of preamble may serve to (e.g., also) provide additional information. For example, a WTRU that (e.g., only) wants to perform initial access (e.g., as per legacy) may use the first (e.g., legacy) type of preamble. A WTRU that is AI/ML capable and/or wants to transmit additional information to the gNB (e.g., on set B) may use the second (e.g., special) type of preamble.

In some examples, preambles (e.g., regular, special, dedicated, contention-based, contention-free) that can be used for initial access may be indicated to the WTRU, for example, via SIB. An SIB may be SIB1, a subsequent (e.g., requested) SIB, a subsequent periodic SIB, an AI/ML specific SIB, and/or a beam measurement specific SIB. For example, an AI/ML capable WTRU may use one of the preambles as indicated via the AI/ML specific SIB to provide the gNB information specific to AI/ML (e.g., Indication of AI/ML capability, etc.).

A WTRU may measure and/or report information on set B during or associated with one or more of the following events: contention-based random access (CBRA); contention-free random access (CFRA); 4-step random access; 2-step random access; initial access from RRC IDLE; RRC Connection Re-establishment procedure; DL or UL data arrival during RRC_CONNECTED (e.g., if/when UL synchronization status is non-synchronized); UL data arrival during RRC_CONNECTED (e.g., if/when PUCCH resources for SR are not available); request by RRC upon synchronous reconfiguration (e.g., handover); RRC connection resume procedure from RRC_INACTIVE; to establish time alignment for a secondary TAG; request for other system information; beam failure recovery (BFR); or consistent UL LBT failure on SpCell.

A measurement beams resource set (Set B) type may be switched. A WTRU may (e.g., be configured to) perform one or more of the following. The WTRU may receive a configuration of one or more of the following: one or more RS resource sets, where a RS resource (e.g., each RS resource) of the one or more RS resource sets is associated with a beam; RS resource selection conditions; and/or an indication of the order of precedence between the RS resource selection conditions. For example, the WTRU may receive reference signal (RS) resource set(s), two RS resource selection conditions, and an indication of a priority of the respective RS resource selection conditions (e.g., relative to one another).

The WTRU may measure one or more RS resources (e.g., each RS resource) of a RS resource set (e.g., each RS resource set). The WTRU may determine a subset of measured RS resources as a set of measurement RS resources (e.g., Set B). The WTRU may select a first RS resource selection condition (e.g., of the received RS resource selection conditions) based on, for example, the indicated priorities (e.g., order of precedence).

The WTRU may determine if a subset of measured RS resources satisfies the selected first RS resource selection condition. The WTRU may select a second RS resource selection condition based on the configured two or more RS resource selection conditions and the indicated priority, for example, if no subset of measured RS resources satisfies the selected first RS resource selection condition. The WTRU may repeat the determination step using the second RS resource condition. A subset of measured RS resources may (e.g., be determined to) satisfy the selected first RS resource selection criterion. The WTRU may determine a set of measurement RS resources as the subset of measured RS resources. The WTRU may transmit an indication (e.g., to a network entity) of one or more of the following: an indication indicating the satisfied RS selection condition; an indication indicating the size of the determined subset of measured RS resources that satisfy the indicated RS selection condition; and/or a report indicating the RS resources belonging to the indicated subset of measured RS resources that satisfy the indicated RS selection condition.

The WTRU may repeat the determination step (e.g., for a subset of resources, Set B) using other RS resource condition(s), for example based on a respective priority of each RS resource condition. The WTRU may transmit an indication requesting fallback to legacy beam management mode, for example, if the WTRU is unable to determine a subset of measured RS resources that satisfies any of the configured (e.g., received) RS selection conditions.

The WTRU may determine a trigger condition (e.g., a channel parameter of the WTRU or a status of the WTRU) is satisfied. The WTRU being configured to determine a subset of resources may be based on the trigger condition being satisfied.

Set B type switching configurations may be provided. A WTRU may receive a configuration of one or more RS resource sets. A (e.g., each) RS resource may be associated with a beam.

A WTRU may receive an (e.g., a 1-bit) indication (e.g., size_type_priority) from a gNB (e.g., via RRC/MAC-CE/DCI based signaling) to indicate priority of changing Set B size over changing Set B type (e.g., fixed Set B/Set B(s) out of a preconfigured Set including multiple Set Bs/random Set B). For example, a value (e.g., 0) may indicate changing Set B type takes priority over changing Set B size.

A WTRU may receive an indication (e.g., type_precedence) indicating the order of precedence for selecting Set B types. For example, a value (e.g., zero (0)) of type_precedence may indicate the order of precedence as fixed Set B greater than one or more Set B out of a preconfigured Set including multiple Set Bs>random Set B. A value (e.g., one (1) of type_precedence may indicate the order of precedence as random Set B greater than one or more Set B out of a preconfigured Set including multiple Set Bs greater than fixed Set B.

Set B type may be switched, reported, and/or a fallback may be performed. A WTRU may switch to a different Set B type or may fall back to a (e.g., legacy) beam management procedure(s), for example, based on the type_precedence indication and/or WTRU mobility. A WTRU may select a fixed Set B, for example, if WTRU's mobility (e.g., speed) is less than mb_threshold1. The WTRU may indicate a preferred fixed Set B to gNB. A WTRU may select one or more Set Bs out of a preconfigured Set including multiple Set Bs, for example, if mb_threshold1 is less than WTRU's mobility, which is less than mb_threshold2 (e.g., where mb_threshold1<mb_threshold2). The WTRU may indicate one or more preferred Set B(s) to a gNB. A WTRU may select a random Set B, for example, if WTRU's mobility is greater than mb_threshold2. The WTRU may indicate the Set B size to the gNB.

A WTRU may switch to a different Set B type or fall back to a (e.g., legacy) beam management procedure(s), for example, based on the type_precedence indication and/or available RS (e.g., or beam) measurements.

For example, a WTRU may search for a predefined/preconfigured fixed Set B whose beams are a subset of measured beams. The WTRU may indicate a preferred fixed Set B to gNB, for example, if the WTRU is successful in its search. The WTRU may (e.g., if the WTRU is unsuccessful in the search of fixed Set B) perform one or more of the following: trigger training a new fixed Set B AI/ML model (e.g., as described herein relating to training/fine-tuning); and/or search for one or more Set Bs out of a preconfigured Set including multiple Set Bs whose beams may be a subset of measured beams. The WTRU may indicate one or more preferred Set B(s) to a gNB, for example, if the WTRU is successful in the search. The WTRU may (e.g., if the WTRU is unsuccessful in the search) perform one or more of the following: trigger training an AI/ML model with a Set including multiple Set Bs (e.g., as described herein regarding training/fine-tuning); and/or switch to a random Set B (e.g., if supported by the gNB and/or WTRU). The WTRU may indicate the Set B size to the gNB.

A WTRU may be unable to find a suitable Set B (e.g., based on accuracy, WTRU capability, and/or gNB supported Set B types). The WTRU (e.g., unable to find a suitable Set B) may: switch back to (e.g., legacy) beam management; and send an indication to the gNB indicating the switch to (e.g., legacy) beam management, e.g., due to unavailability of a suitable Set B.

Set B type switching configurations may be provided. Measurement and/or estimation sets may be configured. A WTRU may be configured with one or more sets of reference signal (RS) resources and/or beams (e.g., or beam-pairs). A (e.g., each) RS resource, beam, and/or beam-pair may be associated with a transmission from a beam of specific beam parameters (e.g., beam direction and/or beam width). The WTRU may be configured with the associated beams, RS resources, and/or beam parameters.

In some examples, a WTRU may be configured with a first set of RS resources, beams, and/or beam-pairs that may cover the (e.g., entire) RS resource-space, bear-space, and/or beam-pair-space. The WTRU may determine or select a set A and a set B. The union of set A and set B may cover the (e.g., entire) RS-resource-space, beam-space, and/or beam-pair-space. In some examples, set A and set B may be mutually exclusive. In some examples, a set B may include RS resources on which the WTRU may perform measurements to obtain one or more of the following: (1) direct measurement values for a first set of beams or beam-pairs (e.g., one-to-one mapping between an RS resource and a beam or beam-pair); and/or (2) estimated measurement values for a second set of beams or beam-pairs (e.g., many-to-one mapping between RS resources and a beam or beam-pair, possibly using an AI/ML estimation model).

A WTRU may switch Set B size or Set B type, for example, by using one or more indications to trigger, report, and/or receive switching configurations of Set B size or type. Switching Set B size may change the number of beams in the measurement beams set. Switching Set B type may change the selection of the beams in the measurement beams set. For example, a Set B type may be fixed (e.g., the members of the measurement beams set may be fixed), may follow one of multiple preconfigured sets (e.g., Set B may follow one of multiple predetermined sets of measurements beams), or may be random (e.g., the members of the measurement beams set may be randomly selected). A WTRU may receive an indication, for example, from a gNB (e.g., via DCI-based signaling, MAC-CE, or RRC signaling).

In some examples, a WTRU may receive an indication to prioritize switching Set B size over switching Set B type or vice versa. For example, an indication may be a 1-bit indication (e.g., size_type_priority) that can be set. A first value (e.g., one (1)) may indicate priority of changing Set B size over changing Set B type. A second value (e.g., zero (0)) may indicate that changing Set B type takes priority over changing Set B size.

Another type of indication (e.g., type_precedence) may be used to set an order of precedence among the possible options for set type switching. The indication may assume multiple values for some/all possible orders of precedence. For example, the indication may be a 1-bit indication. A first value (e.g., the value zero (0)) may indicate the order of precedence as a fixed Set B much greater than random Set B. A second value (e.g., the value one (1)) may indicate the order of precedence as random Set B greater than preconfigured Set B from a predetermined set greater than fixed Set B. In some examples, an indication may (e.g., include multiple bits to) refer to multiple orders of precedence.

Set B type switching, reporting, and fall back procedures may be implemented.

Set B type switching and/or selecting criteria may be determined and/or indicated. A WTRU may (e.g., determine to) change, modify, and/or switch the configured and/or determined Set B type based on one or more of the following: one or more parameters, priorities (e.g., type_precedence), RS measurements, and so forth. For example, a WTRU may (e.g., determine to) switch the beam Set B type to the fixed Set B. A WTRU may (e.g., determine to) switch the beam Set B to one or more Set Bs out of a preconfigured set including multiple Set Bs. A WTRU may (e.g., determine to) switch the Set B type to the random Set B, and so forth.

A WTRU may (e.g., determine to) switch the Set B type based on, for example, one or more of the following: priority and/or type priority; channel parameters; and/or available RS (e.g., or beam) measurements.

A WTRU may (e.g., determine to) switch the Set B type based on priority and/or type priority. For example, the WTRU may determine or receive (e.g., from a gNB) one or more type priorities (e.g., type_precedence) for selecting or switching the Set B type. A WTRU may switch the Set B type to the type that is associated with a first type priority, for example, if the first type priority is selected by the WTRU or configured by the gNB. The WTRU may switch the Set B type to the type that is associated with the second type priority, for example, if a second type priority is selected by the WTRU or configured by the gNB, and so forth.

A WTRU may (e.g., determine to) switch the Set B type based on channel parameters. For example, the WTRU may determine the Set B type based on one or more WTRU's channel parameters and/or statuses. A WTRU may (e.g., determine to) select and/or switch to the fixed beam Set B, for example, if the WTRU determines the WTRU's mobility status to be in a first range (e.g., low mobility). A WTRU may (e.g., determine to) select and/or switch to the fixed beam Set B, for example, if the WTRU's speed is lower than a first threshold. A WTRU may (e.g., determine to) select and/or switch to one or more beam Set Bs out of a preconfigured beam Set including multiple beam Set Bs, for example, if the WTRU's speed is higher than the first threshold and lower than a second threshold. A WTRU may (e.g., determine to) select and/or switch to a random beam Set B, for example, if the WTRU's speed is higher than the second threshold, and so forth. The WTRU may report and/or indicate the selected Set B type (e.g., to the gNB).

A WTRU may (e.g., determine to) switch the Set B type based on available RS (e.g., or beam) measurements. For example, a WTRU may determine the Set B type based on one or more reference signals (RS) that are available and/or are configured to be measured (e.g., as part of measurement beam sets). A WTRU may (e.g., determine to) select or switch to a Set B type, for example, if the beam resources in the selected beam Set B include one or more (e.g., a subset) of measured (e.g., RS) beam resources.

Set B type may be switched and/or reported. A WTRU may search for a Set B type to select or switch to. One or more of the following may apply.

A WTRU may (e.g., determine to) search for a (pre)defined and/or (pre)configured beam Set B with a first Set B type (e.g., fixed Set B). A WTRU may determine the type for the beam Set B based on one or more Set B type switching and/or selection criteria (e.g., as described herein, such as based on the determined or configured type priority, channel parameters, available RS measurements, and so forth).

A WTRU may report and/or indicate the selected Set B type to the gNB, for example, if the WTRU is successful in finding and/or selecting a Set B type with a first type (e.g., fixed Set B).

A WTRU may trigger the training of a new beam Set B AI/ML model based on a first type (e.g., fixed Set B) (e.g., as described herein, related to training/fine-tuning), for example, if the WTRU is unsuccessful in finding and/or selecting a beam Set B with the first type (e.g., fixed Set B). A WTRU may (e.g., alternatively) (e.g., determine to) search for a (pre)defined and/or (pre)configured beam Set B with a second Set B type (e.g., one or more Set Bs out of a preconfigured Set including multiple Set Bs). The WTRU may search for one or more Set Bs out of a preconfigured Set including multiple Set Bs. The (e.g., Tx) beams in the beam Set B may be a subset of the measured (e.g., RS) (e.g., Tx) beams. The WTRU may report and/or indicate one or more of the selected beam Set B(s) to the gNB, for example, if the WTRU is successful in finding and/or selecting a beam Set B with the second type. The WTRU may trigger the training of a new beam Set B AI/ML model based on the second type (e.g., as described herein, related to training/fine-tuning), for example, if the WTRU is unsuccessful in finding and/or selecting a beam Set B with a second type. The WTRU may (e.g., alternatively) (e.g., determine to) search for a (pre)defined and/or (pre)configured beam Set B with a third Set B type (e.g., random Set Bs). The WTRU may report and/or indicate the size of the selected Set B type to the gNB.

Set B type switching may fail. A WTRU may determine whether a selected Set B type is suitable and/or whether performance requirements are met. A WTRU may determine whether a selected Set B type is suitable, for example, based on one or more of the following: accuracy, WTRU capability, gNB support for the Set B types, and so forth.

A WTRU may determine whether a selected Set B type is suitable based on accuracy. For example, the WTRU may determine and/or calculate the accuracy of the selected Set B type based on one or more (e.g., measured) parameters (e.g., RSRP, BLER, RSRQ, CQI, and so forth). The WTRU may determine that the selected Set B type is suitable, for example, if the determined accuracy (e.g., measured parameter) is within a first range (e.g., higher than a corresponding threshold). The WTRU may determine that the selected Set B type is not suitable, for example, if the determined accuracy (e.g., measured parameter) is not within the first range (e.g., lower than a corresponding threshold).

A WTRU may determine whether a selected Set B type is suitable based on WTRU capability. For example, the WTRU may determine the WTRU capability and/or whether a selected Set B type is supported by the WTRU. The WTRU may determine that the selected Set B type is suitable, for example, if the selected Set B type is supported by the WTRU. The WTRU may determine that the selected Set B type is not suitable, for example, if the selected Set B type is not supported by the WTRU.

A WTRU may determine whether a selected Set B type is suitable based on gNB support for the Set B types. For example, the WTRU may determine whether a selected Set B type is supported by the gNB. The WTRU may receive the Set B(s) types that may be supported by the gNB via an indication (e.g., SIB, DCI, MAC-CE, RRC, and so forth). The WTRU may determine that the selected Set B type is suitable, for example, if the selected Set B type is supported by the gNB. The WTRU may determine that the selected beam Set B type is not suitable, for example, if the selected beam Set B type is not supported by the gNB.

A WTRU may be configured to fallback to legacy beam management procedures (e.g., without AI/ML models), for example, if the Set B AI/ML model does not meet performance requirements. In an example, the WTRU may determine that none of the selected and/or supported Set B(s) types are suitable (e.g., the WTRU may determine that the WTRU was unable to find any suitable beam Set B (type). The WTRU may (e.g., accordingly) fall back or switch back to another (e.g., legacy) beam management scheme. The WTRU may send a report or indication to the gNB to indicate the switch to another (e.g., legacy) beam management. The WTRU may (e.g., additionally and/or alternatively) indicate the reason for switching back is the unavailability of a suitable Set B.

A WTRU may implement AI/ML model training/fine-tuning procedures.

A WTRU may receive a configuration of supported training types via RRC/MAC-CE (e.g., CSI-Config) from the gNB. For example, the WTRU may receive a (e.g., 4-bit) configuration parameter (e.g., training_config), which may indicate supported training procedure types, e.g., with a first value (e.g., one (1)) indicating supported and a second value (e.g., zero (0)) indicating otherwise. Online training (e.g., training an AI/ML model from scratch within a time-window) may be indicated by the configuration parameter (e.g., by Bit1). Offline training (e.g., training an AI/ML model from scratch without a time-restriction) may be indicated by the configuration parameter (e.g., by Bit2). Online fine-tuning (e.g., incremental-training of an already trained AI/ML model within a time-window) may be indicated by the configuration parameter (e.g., by Bit3). Offline fine-tuning (e.g., incremental-training of an already trained AI/ML model without a time-restriction) may be indicated by the configuration parameter (e.g., by Bit4).

A WTRU may send an indication requesting the type of training procedure (e.g., via CSI-Report) within the supported types by the gNB. For example, the WTRU may send an (e.g., a 2-bit) indication (e.g., training_ind), which may indicate the type of training procedure requested (e.g., where: 00 may indicate online training, 01 may indicate offline training, 10 may indicate online fine-tuning, 11 may indicate offline fine-tuning). The WTRU may (e.g., also) indicate time-window for online training/fine-tuning, for example, based on the WTRU indication (e.g., training_ind). The time-window may be determined from the specification/capability of an AI/ML model, a configuration by the gNB, and/or part of WTRU capability.

A WTRU may indicate, for example, one or more of the following from the gNB: Set B size (for random Set B); preferred Set B(s); additional information from gNB (e.g., beam IDs, QCL-TypeD); and/or number of RS measurements (e.g., periodic beam sweeps of Set B) requested. The WTRU may determine the number of RS measurements needed, for example, based on training_ind (e.g., small number of measurements for fine-tuning compared to training) and/or AI/ML model specification.

The WTRU may send an indication indicating RS measurements (e.g., periodic beam sweeps) are no longer needed, for example, if/when one or more of the following occurs: the WTRU completes online training/fine-tuning of an AI/ML model within the time-window; and/or the WTRU collects (e.g., sufficient) measurements for offline training/fine-tuning of an AI/ML model.

The WTRU may send an indication indicating RS measurements (e.g., periodic beam sweeps) are no longer needed if/when the WTRU completes online training/fine-tuning of an AI/ML model within the time-window. The WTRU may stop receiving RS resources after the training/fine-tuning time-window passes, for example, regardless of outcome (e.g., even if training/fine-tuning is not completed).

A WTRU may indicate WTRU capability on one or more supported training types. The WTRU may indicate supported training procedure types, for example, via one or more of RRC, MAC CE, and DCI.

For example, the WTRU may indicate WTRU capability (e.g., with 4 bits). The indication may indicate supported training procedure types, for example, with the bit value one (1) indicating supported and the bit value zero (0) indicating otherwise. Online training (e.g., training an AI/ML model from scratch within a time-window) may be indicated (e.g., by Bit 1). Offline training (e.g., training an AI/ML model from scratch without a time-restriction) may be indicated (e.g., by Bit 2). Online fine-tuning (e.g., incremental-training of an already trained AI/ML model within a time-window) may be indicated (e.g., by Bit 3). Offline fine-tuning (e.g., incremental-training of an already trained AI/ML model without a time-restriction) may be indicated (e.g., by Bit 4).

A WTRU may indicate WTRU capability (e.g., with 2 bits). The indication may indicate supported training procedure types. Support for online and offline training may be indicated (e.g., by Bit1, where value 1 may indicate support for online and offline training and value 0 may indicate support for (e.g., only) offline training). Support for online and offline fine-tuning may be indicated (e.g., by Bit2, where value 1 may indicate support for online and offline fine-tuning and value 0 may indicate support for (e.g., only) offline fine-tuning). In some examples, Bit2 may be enabled (e.g., only) if the value of Bit1 is one (1). Otherwise (e.g., if Bit1 is 0), fine-tuning may not be supported or (e.g., only) offline fine-tuning may be supported, e.g., regardless of Bit2.

A WTRU may receive a configuration (e.g., based on the reported WTRU capability) of one or more supported training types, for example, via one or more of RRC, MAC-CE (e.g., CSI-Config), and/or DCI from a gNB. The WTRU may receive an indication or a configuration of supported training procedure types.

For example, the WTRU may receive a configuration parameter (e.g., training_config) and/or an indication (e.g., with 4 bits), indicating supported training procedure types (e.g., with the bit value 1 indicating supported and 0 otherwise). Online training (e.g., training an AI/ML model from scratch within a time-window) may be indicated (e.g., by Bit1), Offline training (e.g., training an AI/ML model from scratch without a time-restriction) may be indicated (e.g., by Bit2). Online fine-tuning (e.g., incremental-training of an already trained AI/ML model within a time-window) may be indicated (e.g., by Bit3). Offline fine-tuning (e.g., incremental-training of an already trained AI/ML model without a time-restriction) may be indicated (e.g., by Bit4).

For example, the WTRU may receive a configuration and/or an indication (e.g., with 2 bits), indicating supported training procedure types. Support for online and offline training may be indicated (e.g., by Bit1, where a value of 1 may indicate support for both online and offline training and a value of 0 may indicate support for (e.g., only) offline training). Bit2: 1: Support for online and offline fine-tuning may be indicated (e.g., by Bit2, where a value of 1 may indicate support for both online and offline fine-tuning and a value of 0 may indicate support for (e.g., only) offline fine-tuning). In some examples, Bit2 may be enabled (e.g., only) if the value of Bit1 is 1. Otherwise (e.g., if the value of Bit1 is 0), fine-tuning may not be supported or (e.g., only) offline fine-tuning may be supported, e.g., regardless of Bit2.

A WTRU may send an indication requesting an additional training procedure and/or type of training procedure, e.g., within the supported types indicated/configured by the gNB. The indication may be based on one or more of the following: an AI/ML model type (e.g., CSI or BM), AI/ML model ID, beam pattern type, CSI configuration ID, etc.; a 1-bit indication; a 2-bit indication; a time-window for training/fine-tuning (e.g., online or offline); one or more resources for measurements; and/or a number and/or duration of (e.g., required) RS measurements.

A WTRU may send a 1-bit indication requesting an additional training procedure and/or type of training procedure. For example, a first value (e.g., zero (0) may indicate additional training is not needed and a second value (e.g., one (1) may indicate additional training is needed. In some examples, the indication may be based on toggling. For example, if a new indication is the same as a previous indication (e.g., no toggling), the new indication may indicate additional training is not needed. If the new indication is different from the previous indication (e.g., toggling), the new indication may indicate additional training is needed.

The WTRU may send a 2-bit indication (e.g., training_ind) indicating an additional training procedure and/or type of training procedure requested. For example, the value 00 may indicate online training, the value 01 may indicate offline training, the value 10 may indicate online fine-tuning, and the value 11 may indicate offline fine-tuning.

The WTRU may indicate a time-window for training/fine-tuning (e.g., online or offline) to request an additional training procedure and/or type of training procedure. The time-window may be determined from the spec/capability of an AI/ML model, configured by the gNB, and/or part of a WTRU capability.

The WTRU may indicate one or more resources for measurements to request an additional training procedure and/or type of training procedure.

The WTRU may indicate a preferred size (e.g., number) of beams (e.g., size of Set B). The indication may exist or apply, for example, (e.g., only) if the WTRU indicated a random selection of measurement beams (e.g., random Set B).

The WTRU may indicate preferred sets of measurement beams (e.g., preferred Set B(s)). For example, the WTRU may indicate one or more preferred sets of measurement beams. The indication may be based on indicating one or more of the following: time/frequency resources, CSI-RS resource set IDs, CSI-RS resource IDs, beam IDs, beam pair IDs, beam group IDs, CSI resource configuration IDs, etc.

The WTRU may indicate additional information to the gNB. The WTRU may indicate additional information for the training procedure. For example, the additional information may be one or more of the following: beam IDs, QCL info (e.g., QCL Type-A and/or D), etc.

The WTRU may indicate additional information (e.g., required) from a gNB. The WTRU may indicate additional information for the training procedure. For example, the WTRU may request to receive additional information from the gNB. The additional information may be one or more of the following: beam IDs, QCL information (e.g., QCL Type-A and/or D), etc. The WTRU may receive the indication (e.g., beam IDs, QCL information) via one or more of PDCCH (e.g., via DCI and/or receiving PDCCH in associated CORESETs/SearchSpaces with related information), PDSCH, and/or RS transmission (e.g., receiving RSs in associated RS resources/resource sets and/or associated RS sequences (with sequence IDs) with related information).

The WTRU may indicate a number and/or duration of (e.g., required) RS measurements. The WTRU may indicate a (e.g., required) number and/or duration of RS measurements for the training procedure. The indication may be based on one or more of a time window (e.g., one or more of msec, nsec, symbols, slots, frames, etc.), periodicity, offset, number of beam sweeps (e.g., for periodic/semi-persistent RS).

The WTRU may determine a set of parameters, for example, based on the indicated type of training procedure. For example, the WTRU may be configured with sets of parameters for (e.g., required) RS measurements. The sets of parameters may be (pre)defined, (pre)configured, and/or determined, for example, based on the indicated type of training procedure. In some examples, a set of parameters may be associated with online training/fine-tuning and another set of parameters may be associated with offline training/fine-tuning. In some examples, a set of parameters may be associated with a (e.g., each) type, respectively (e.g., a set for each of online training, online fine-tuning, offline training, and offline fine-tuning).

A WTRU may receive one or more RS resources (e.g., within the indicated time window and/or the duration). The WTRU may train and/or fine-tune one or more AI/ML models, for example, based on the received one or more RS resources. The WTRU may (e.g., based on the received one or more RS resources) indicate one or more of the following to the gNB: complete training/fine-tuning or incomplete training/fine-tuning.

The WTRU may indicate that the WTRU completed training/fine-tuning, for example, based on the WTRU request and/or the requested RS resources. The WTRU may stop receiving the requested RS resources. For example, the WTRU may assume that the requested RS resources are not transmitted and/or that PDSCHs are transmitted, for example, if PDSCHs are scheduled in the time/frequency resources.

The WTRU may indicate that the training/fine-tuning is incomplete. The WTRU may support one or more of the following procedures (e.g., after the indication). The WTRU may indicate additional training/fine-tuning to the gNB and/or continue the training/fine-tuning procedure based on the WTRU indication. The WTRU may assume that the requested RS resources are not transmitted and/or that PDSCHs are transmitted, for example, if PDSCHs are scheduled in the time/frequency resources. The WTRU may determine whether to continue the training/fine-tuning procedure. For example, the WTRU may indicate one or more parameters. The WTRU may continue the training/fine-tuning, for example, if the one or more parameters are larger than one or more thresholds. The WTRU may stop the training/fine-tuning, for example, if the parameters are smaller than (e.g., or equal to) the one or more thresholds. The one or more parameters may be one or more of the following: percentage of completeness of training/fine-tuning; training/fine-tuning speed (e.g., percentage/time window or duration); WTRU recommendation (e.g., continue or stop training/fine-tuning); LOS probability (e.g., LOS probability in percentage or 1 bit, where 0 indicates NLOS and 1 indicates LOS); and/or Quality parameters (e.g., RSRP, RSRQ, SINR, CQI, hypothetical PDCCH BLER, etc.).

A WTRU indication may be based on one or more of PUCCH, PUSCH, PRACH, RS transmission (e.g., SRS), and/or CSI reporting.

Common methods may be used for beam prediction, reporting, and/or application.

The WTRU may, for example, based on the indicated preferred Set B size (e.g., number of beams/RS resources in Set B) and/or preferred beams/RS resources in Set B, perform one or more of the following: receive a configuration of an RS resource set associated with the number of beams equal to or greater than the size of Set B; receive a configuration of an RS resource set associated with the indicated beams of Set B; measure the RS resources associated with Set B beams to determine beam quality (e.g., L1-RSRP); use the measured beam quality values to predict (e.g., via Al/ML model) K best beams; report one or more top predicted beams to the gNB; and/or receive a configuration of a new DL beam (e.g., an indication of the top predicted DL beam via TCI-state).

A WTRU may be configured with one or more sets of reference signal (RS) resources and/or beams (e.g., or beam-pairs). A (e.g., each) RS resource, beam, and/or beam-pair may be associated with a transmission from a beam with (e.g., specific) beam parameters (e.g., beam direction and/or beam width). The WTRU may be configured with the associated beams, RS resources, and/or beam parameters.

For example, the WTRU may receive a configuration of RS resources based on at least one of the following: a preconfigured Set B (e.g., beams or beam measures RS resources) and/or Set B size; the WTRU's indicated Set B or Set B size; and/or a preconfigured Set B type and/or determination/selection rule(s)/criterion(s).

The WTRU may measure one or more RS resources to determine beam quality measurements (e.g., L1-RSRP, CQI, RI, SINR, RSSI). For example, the WTRU may measure an RS resources belonging to a Set B.

The WTRU may receive a configuration beam/beam RS resource report (e.g., via RRC CSI-ReportConfig). The WTRU may receive an (e.g., a 1-bit) indication (e.g., via RRC/MAC-CE/DCI) indicating to report AI/ML predicted beams. For example, the WTRU may be configured with beam reporting parameter (e.g., K) indicating the number of beams to be reported.

The WTRU may predict the top-K beams, for example, using an AI/ML model based on one or more of the following: RS resources measurements (e.g., beam qualities e.g., L1-RSRP, CQI, SINR, RSSI); and/or Set B size, Set B type, and/or RS resources associated with Set B.

The WTRU may send a report indicating predicted beams based on the received beam report-configuration. For example, the WTRU may indicate the CRIs of an RS associated with one or more (e.g., top K) predicted beams. For example, the WTRU may indicate beam IDs and/or beam angles of one or more predicted beams. For example, the WTRU may indicate beam angles of one or more predicted beams.

The WTRU may receive an indication of TCI-state (e.g., via RRC, MAC-CE, and/or DCI), for example, based on the WTRU's indication of RS resources/beams (e.g., AI/ML predicted beams, CRI of RS resources associated with predicted beams). The WTRU may receive (e.g., future) PDSCH and/or PDCCH resources using the indicated TCI-state.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU) comprising:
a processor configured to:
receive configuration information that indicates: one or more reference signal (RS) resource sets, a first RS resource selection condition and a second RS resource selection condition, an indication of a first priority associated with the first RS resource selection condition, and an indication of a second priority associated with the second RS resource selection condition;
perform measurements on RS resources, wherein the measurements comprise measurements on RS resources associated with a respective RS resource set of the one or more RS resource sets;
determine a subset of resources using the indicated priorities, wherein the subset of resources is a subset of the measured RS resources and is determined based on one of the first RS resource selection condition or the second RS resource selection condition; and
transmit an indication, wherein the indication is at least one of: an indication of a size of the determined subset of resources or an indication of RS resources that belong to the determined subset of resources.

2. The WTRU of claim 1, wherein the processor being configured to determine the subset of measured RS resources using the indicated priorities comprises the processor being configured to:
determine the first priority is greater than the second priority;
determine that none of the measured RS resources satisfy the first RS resource selection condition; and
determine, based on the determination that the first priority is greater than the second priority and the determination that none of the measured RS resources satisfy the first RS resource selection condition, the subset of resources based on the subset of the measured RS resources satisfying the second RS resource selection condition.

3. The WTRU of claim 2, wherein the indication comprises an indication of the second RS resource selection condition being satisfied.

4. The WTRU of claim 2, wherein the processor being configured to determine the subset of resources using the indicated priorities comprises the processor being configured to:
determine that none of the measured RS resources satisfy the second RS resource selection condition, wherein the indication comprises a request to fallback to a legacy beam management mode.

5. The WTRU of claim 1, wherein the processor being configured to determine the subset of resources using the indicated priorities comprises the processor being configured to:
determine the first priority is greater than the second priority; and
determine the subset of resources based on the subset of measured RS resources satisfying the first RS resource selection condition.

6. The WTRU of claim 1, wherein the processor is further configured to:
determine a trigger condition is satisfied, wherein the processor being configured to determine the subset of resources is based on the trigger condition being satisfied, and wherein the trigger condition is at least one of: a channel parameter of the WTRU or a status of the WTRU.

7. The WTRU of claim 6, wherein the trigger condition is a mobility associated with the WTRU being below a threshold.

8. The WTRU of claim 1, wherein the processor is further configured to determine an accuracy associated with the subset of resources.

9. A method implemented in a wireless transmit/receive unit (WTRU) comprising:
receiving configuration information that indicates: one or more reference signal (RS) resource sets, a first RS resource selection condition and a second RS resource selection condition, an indication of a first priority associated with the first RS resource selection condition, and an indication of a second priority associated with the second RS resource selection condition;
performing measurements on RS resources, wherein the measurements comprise measurements on RS resources associated with a respective RS resource set of the one or more RS resource sets;
determining a subset of resources using the indicated priorities, wherein the subset of resources is a subset of the measured RS resources and is determined based on one of the first RS resource selection condition or the second RS resource selection condition; and
transmitting an indication, wherein the indication is at least one of: an indication of a size of the determined subset of resources or an indication of RS resources that belong to the determined subset of resources.

10. The method of claim 9, wherein determining the subset of measured RS using the indicated priorities comprises:
determining the first priority is greater than the second priority;
determining that none of the measured RS resources satisfy the first RS resource selection condition; and
determining, based on the determination that the first priority is greater than the second priority and the determination that none of the measured RS resources satisfy the first RS resource selection condition and the second priority being lower than the first priority, the subset of measured RS resources based on the subset of measured RS resources satisfying the second RS resource selection condition.

11. The method of claim 10, wherein the indication comprises an indication of the second RS resource selection condition being satisfied.

12. The method of claim 10, wherein determining the subset of resources using the indicated priorities comprises:
determining that none of the measured RS resources satisfy the second RS resource selection condition, wherein the indication comprises a request to fallback to a legacy beam management mode.

13. The method of claim 9, further comprising:
determining a trigger condition is satisfied, wherein determining the [a] subset of resources is based on the trigger condition being satisfied, and wherein the trigger condition is at least one of: a channel parameter of the WTRU or a status of the WTRU.

14. The method of claim 13, wherein the trigger condition is a mobility associated with the WTRU being below a threshold.

15. The method of claim 9, further comprising:
determining an accuracy associated with the subset of resources.
